(19) United States
(12) Patent Application Publication
(10) Pub. No.: US 2002/0023053 A1
(43) Pub. Date: Feb. 21, 2002

(54) System, method and apparatus for international financial transactions

(76) Inventors: Ronald Z. Szoc, Washington, DC (US); Radomir Zamurovic, Potomac, MD (US); Jim Lesure, Edgewater, MD (US); Jeremy Shanahan, Annandale, VA (US)

Correspondence Address: HOWREY SIMON ARNOLD & WHITE LLP, BOX 34, 1299 PENNSYLVANIA AVENUE NW, WASHINGTON, DC, 20004, US

(21) Appl. No.: 09/825,366

(22) Filed: Apr. 4, 2001

Related U.S. Application Data
(60) Provisional application No. 60/194,587, filed on Apr. 5, 2000.

(51) Int. Cl. G06F 17/60

(52) U.S. Cl. 705/39

(57) ABSTRACT

An apparatus, system and method for providing real-time foreign exchange information, cross-border payments, and other financial information and services to clients over the World Wide Web. Real-time foreign exchange rate quotes are provided that may be relied on in timing international transactions to a benefit of a consumer. Single or multiple transactions are automatically converted from a consumer's native currency to any of a plurality of foreign currencies and vice versa, thereby simplifying and facilitating these international transactions.

### RELATED APPLICATIONS

This application claims the benefit of U.S. Provisional Application No. 60/194,587, entitled System for International Financial Transactions, filed on Apr. 5, 2000.

### BACKGROUND OF THE INVENTION

1. Copyright

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

2. Field of the Invention

The present invention relates generally to a system for offering information and conducting transactions over a network. More specifically, the present invention relates to an apparatus, system and method for providing real-time foreign exchange rate quotes, cross-border payments, and other financial information and services to clients over the Internet and World Wide Web.

3. Related Art

In recent years, the global expansion of such public computer networks as the Internet and associated World Wide Web has linked together individuals and corporate entities from all over the globe. With this expansion, international electronic commerce (e-commerce) has become commonplace. Web users are now able to access not only a wealth of information on a great range of topics, but also to buy, sell and trade products and services in an almost endless variety of industries.

One industry that has taken advantage of the expansion of the Internet is the financial services industry. Internet users can currently conduct online virtually any personal financial transaction that was traditionally conducted solely in brick and mortar banking facilities. On the international front, web users can wire funds to foreign countries, transact with foreign merchants, and a plurality of other personal and commercial activities.

While the global nature of today's Internet has greatly facilitated electronic transactions, certain international barriers must still be overcome in order to render the Internet a fully effective vehicle for international finance. Of predominant significance is the fact that different nations and regions use many different forms of currency. To complicate matters, because of various international market factors, it is common for a value of each form of currency to be constantly changing with respect to values of other forms of currency. Hence, the concept of foreign exchange rates, which are measures of the respective values of currencies. The volatile nature of exchange rates has been an impediment to what could otherwise be straightforward international transactions. Exchange rate volatility introduces financial risk and uncertainty, which can have large negative consequences to parties involved in a cross-border or international transaction. This risk is absent in transactions in which the currencies of parties to the transaction are the same. In short, the element of risk makes international transactions fundamentally different from other types of transactions.

Systems are known which consider foreign exchange rates to facilitate international transactions. Unfortunately, each of these systems suffers certain drawbacks. For example, one known system discloses an arrangement for approving a multi-currency transaction between a consumer and a merchant over a network. The system compares an amount a consumer is willing to pay in a first currency with an amount a merchant demands in a second currency. Based on the comparison, the system determines if an exchange rate risk associated with the transaction is within a range acceptable to the system. If so, the transaction will be approved, the amount in the first currency will be received from the consumer by the system, and the amount in the second currency will be paid to the merchant. Once approved, the transaction is fixed with respect to the consumer and merchant, while the risk of loss from further exchange rate changes is assumed by an operator of the system within certain limits.

However, because this known system decides whether or not to approve the transaction, the system acts as a third party to the transaction, and the system is in position to take advantage of favorable changes in exchange rate. For example, the system may elect to only approve transactions where, because of an increase in value of a consumer's currency with respect to a merchant's currency, the transaction may be completed without exhausting the agreed-upon amount to be paid by the consumer. The consumer will be deprived of the excess while the operator of the system benefits.

As can be readily appreciated, the above-described system suffers numerous drawbacks in brokering transactions between international entities. To encourage use of financial systems on the Internet, it would be desirable to provide a system that allows consumers to benefit from the timing of their own transactions, without interference of a third party, and without having to manage the risk themselves. The elements of risk and uncertainty would preferably be removed. What is needed is a system through which consumers may receive real-time foreign exchange rate quotes and be able to rely on the same for a period of time, thereby allowing the consumers to control the timing of their international transactions to their benefit. What is needed is system to remove price and conversion uncertainties by displaying prices that may be relied on by consumers. Such a superior and novel system, as is described herein, would preferably remove risk and uncertainty from such transacting parties as buyers and sellers and consumers and vendors.

### SUMMARY OF THE INVENTION

The present invention relates to an apparatus, system and method for providing real-time foreign exchange rate quotes, cross-border payments, and other financial information and services to clients over a network such as the Internet.

In one aspect, the present invention provides a method and associated apparatus for providing a foreign exchange rate quote to a client over a public network. The method includes obtaining a current rate from a quote source, accessing secondary information and calculating a modified rate quote based on the current rate and the accessed secondary information. The modified rate quote may then be provided to the client.

In another aspect, a method and associated apparatus for generating a draft conforming to requirements of any of a plurality of financial centers are provided. The method includes receiving from a financial center a sample draft. From the sample draft, a set of draft requirements is determined. The method further includes electronically storing the set of draft requirements and producing a draft based on the stored set of draft requirements.

In yet another aspect, the present invention provides a method and associated apparatus for scheduling international transactions for a client. The method includes transmitting real-time foreign exchange rate information to the client and receiving an order for a plurality of transactions to be conducted in a plurality of currencies. This plurality of transactions may be based on the transmitted foreign exchange rate information. The method further includes scheduling execution of at least one of the plurality of transactions and arranging for billing the client upon execution of the at least one of the plurality of transactions in a native currency of the client. Preferably, scheduled transaction or transactions are to be executed with respect to any of a number of beneficiaries previously designated by the client.

Features and Advantages

One feature of the present invention is that it provides real-time foreign exchange rate quotes that may be relied upon by consumers for a predetermined period of time. In one embodiment, quotes derived from spot rates are provided. In another embodiment, forward rate quotes are provided. In yet another embodiment, forward rate quotes in the form of rate ‘points’ are provided. Preferably, forward rate quotes are provided as quotes or rate at an option of a client or potential client. The above features remove price and currency conversion uncertainties, thereby allowing consumers to time international financial transactions to their benefit.

Another feature of the present invention is its passive nature, which allows consumers to conduct financial transactions without interference from a system of the present invention, and to maintain full control over their own accounts.

Yet another feature of the present invention provides for issuance of a payment instrument from funds in a consumer's account.

Still yet another feature of the present invention de-couples the act of issuing a payment instrument from acquiring funds to be used in payment.

Further features and advantages will become apparent following review of the detailed description set forth below.

### BRIEF DESCRIPTION OF THE FIGURES

The present invention is described with reference to the accompanying drawings. In the drawings, like reference numbers indicate identical or functionally similar elements.

FIG. 1 illustrates a block diagram of an embodiment of a system of the present invention;

FIG. 2 illustrates an embodiment of a homepage for a system of the present invention;

FIG. 3 illustrates an embodiment of a main menu page including a main menu bar for a system of the present invention;

FIGS. 4A and 4B illustrate alternative embodiments of pay today pages for a system of the present invention;

FIGS. 5A, 5B and 5C illustrate various embodiments of cash flow pages for a system of the present invention;

FIG. 6 illustrates an embodiment of a beneficiary maintenance page for a system of the present invention;

FIG. 7 illustrates an embodiment of a computer system suitable for use in implementing the present invention; and

FIG. 8 illustrates an embodiment of a network suitable for use in implementing the present invention.

### DETAILED DESCRIPTION OF THE PREFERRED EMBODIMENTS

Overview

The present invention is an improved apparatus, system and method for providing real-time exchange rate quotes to clients and brokering international transactions for clients relying on the quotes. In providing the rate quotes, the system preferably considers various factors specific to a client as well as the client's desired transaction.

An apparatus, system and method of the present invention are preferably implemented on a network, such as the Internet. The network may be public, or may be a private intranet or limited-access extranet, for example. Regardless, the following discussion is intended to provide general background information with regard to network-related technology, to define and/or to provide clarity to various terms used in the present invention, and to provide a description of various hardware and software tools that may be used to implement the present invention. Any reference to products is made for exemplary and/or explanatory purposes only. The breadth and scope of the present invention should not be limited by any of the exemplary products or definitions disclosed herein.

The Internet is generally defined as a collection of processing systems and/or networks that are themselves globally networked together. The World Wide Web is generally defined by all of the resources and users on the Internet that are using Hypertext Markup Language (HTML) as the authoring language and Hypertext Transport Protocol (HTTP) and other related protocols as the transport protocol. The systems and networks of the global network are connected via any of a number of protocols, such as the TCP/IP (Transmission Control Protocol/Internet Protocol).

TCP/IP is the basic communication language or protocol of the Internet. This and other related protocols provide for file transfer, remote log-in, electronic mail, and other services, including distributed processing, as well as other resources. In addition TCP/IP enables an IP data packet from a source node, such as a processing system, to traverse multiple networks on its way to a final destination node without first establishing a virtual circuit or ‘connection.’ When a computer is set up with direct access to the Internet, the computer is enabled for is TCP/IP services just as every other computer that messages are sent to, or information is received from, also has a copy of TCP/IP.

HTML is the set of ‘markup’ symbols or codes inserted in a file intended for display on a World Wide Web browser. The markup tells the web browser how to display a web page's words and images for the user. HTTP is the set of rules for exchanging files (text, graphic images, sound, video and other multimedia files) on the World Wide Web. Relative to the TCP/IP suite of protocols, HTTP is an application protocol. HTTP is typically designed to run primarily over TCP/IP and uses the standard Internet setup, where a server issues the data and a client machine or “client browse” displays the data. One format for information transfer is to create documents using HTML, which are preferably made up of standard text as well as formatting codes that indicate how the page should be displayed. The web client machine reads these codes in order to display the page. The hypertext conventions and related functions of the World Wide Web are described in the appendices of U.S. Pat. No. 5,715,314, the entirety of which is herein incorporated by reference.

HTTPS (HTTP Secure) is a web protocol developed by Netscape® and built into its browser that encrypts and decrypts user page requests as well as the pages that are returned by the web server. HTTPS uses Netscape's Secure Socket Layer (SSL) as a sublayer under its regular HTTP application layer. SSL can use, for example, a 40-bit or 128 bit key size for the stream encryption algorithm.

A Common Gateway Interface (CGI) is a small program written in a script language such as Pearl that functions as the glue between HTML pages and other programs on the web server. For example, a CGI script would allow search data entered on a web page to be sent to the DBMS (database management system). It would also format the results of that search onto an HTML page, which is sent back to the user.

A Uniform Resource Locator (URL) is the address of a file (resource) accessible on the Internet. The type of resource depends on the Internet application protocol. Using HTTP, the resource can be an HTML page, an image file, a program such as a CGI application or Java® applet, or any other file supported by HTTP. The URL contains the name of the protocol required to access the resource, a domain name that identifies a specific computer on the Internet and a hierarchical description of a file location on the computer. Additional descriptions of URLs can be found in the appendices to U.S. Pat. No. 5,715,314, and in U.S. Pat. No. 5,774,670, the entirety of which is herein incorporated by reference.

A browser system is a program that provides a way to look at, read and hear all the information on the World Wide Web. A browser typically interprets hypertext links, or simple ‘links,’ and allows the user to view sites and navigate from one Internet node to another. A brief overview of web browsers and their interactions within the World Wide Web, and the act of ‘browsing,’ which refers to browsing web sites on the World Wide Web, are set forth in U.S. Pat. No. 5,774,670. Browsing also refers to a process of moving between HTML pages of a single typical web site. These HTML web page files, or web pages, may include a ‘homepage,’ by which is meant a main page of a web site that typically names and describes the site, and provides links to other web pages or various features of the web site. Browsing is typically controlled by a Web user through ‘clicking’ on links to web sites or web pages. Clicking refers to a process of indicating a desired link by using a cursor control device, such as a mouse or roller ball.

A cookie is a special text file that a Web site puts on a hard disk or other memory device of a user machine accessing the web site so that it can remember something about the user at a later time. Typically, a cookie records a user's preferences when using a particular site. Using HTTP, each request for a Web page is independent of all other requests. For this reason, the Web page server has no memory of what pages it has sent to a user previously or anything about the user's previous visits. A cookie is a mechanism that allows the server to store its own file about a user on the user's own computer. The file is stored in a subdirectory of the browser directory. The cookie subdirectory will contain a cookie file for each Web site the user has been to that uses cookies. An exemplary specification for cookies can be found at http://www.netscape.com/newsref/std/cookie_spec.html, which is herein incorporated by reference in its entirety. A detailed description of cookies, and the storage of state information, is contained in U.S. Pat. No. 5,774,670.

In general computer usage, logon is the procedure used to get access to an operating system or application, usually in a remote computer. Generally, a logon procedure requires that the user have (1) a user ID and (2) a password. Often, the user ID must conform to a limited length such as eight characters and the password must contain at least one digit and not match a natural language word. The user ID can be freely known and is visible when entered at a keyboard or other input device. The password must be kept secret (and is not displayed as it is entered). A similar procedure, called registration, is required to enter some Web sites.

ActiveX Data Objects (ADO) is an application program interface (API) from Microsoft Corporation, Redmond, WA (“Microsoft”) that lets programmers writing Windows®, a registered trademark of the Microsoft Corporation, Redmond, Wash., applications get access to relational and non-relational databases from both Microsoft and other database providers. For example, if it was desired to write a program that would provide users of a Web site with data from an IBM DB2 database or an Oracle database, an ADO program statements could be included in an HTML file that was identified as an Active Server Page (ASP). When a user requested the page from the Web site, the page sent back could include appropriate data from a database, obtained using ADO code.

Active X is a software module based on Microsoft's Component Object Model (COM) architecture. It enables a program to add functionality by calling ready-made components that blend in and appear as normal parts of the program. They are typically used to add user interface functions, such as 3-D toolbars, a notepad, calculator or even a spreadsheet.

An ActiveX control is a component program object that can be re-used by many application programs within a computer or among computers in a network. The technology for creating ActiveX controls is part of Microsoft's overall ActiveX set of technologies, chief of which is the Component Object Model (COM). ActiveX controls can be downloaded as small programs or animations for Web pages, but they can also be used for any commonly needed task by an application program in the latest Windows® and Macintosh®, a registered trademark of Apple Computer, Inc., Cupertino, Calif., environments.

An animated GIF is a graphic image on a Web page that moves, e.g. a twirling icon or a banner with a hand that waves or letters that get larger. In particular, an animated GIF is a file in the Graphics Interchange Format specified as GIF89a that contains within the single file a set of images that are presented in a specified order. An animated GIF can loop endlessly or it can present one or a few sequences and then stop the animation.

An Active Server Page is a Web page that contains programming code written in VB Script or Javascript. This code was developed by Microsoft starting with Version 3.0 of its Internet Information Server (IIS). When the IIS server encounters an Active Server page that is requested by the browser, it executes the embedded program. Active Server Pages are Microsoft's alternative to CGI scripts, which allow Web pages to interact with databases and other programs.

Client/server is an architecture in which the client machine (personal computer or workstation) is the requesting machine and the server is the supplying machine, both of which are connected via a local area network (LAN) or wide area network (WAN). Since the early 1990s, the client/server architecture has been used to build applications on LANs in contrast to centralized minicomputers and mainframes with dedicated terminals. The client machine contains the user interface and, in terms of the present invention, preferably performs none or very little of the application processing. A client machine may also be referred to herein as a “user machine” or “user.” Servers can be high-speed microcomputers, minicomputers or even mainframes. A database server maintains the databases and processes requests from the client machine to extract data from, or update, the database. An application server may provide additional business processing for the client machine.

Encryption is the conversion of data into a form, called a cipher, that cannot be easily intercepted by unauthorized people. Decryption is the process of converting encrypted data back into its original form, so it can be understood. Typically, when an encrypted document arrives at its destination, the encrypted document is converted back to its original form through decryption. The readable document is generally referred to as a “decrypted” document. A basic introduction to encryption and decryption is described in the text written by Bruce Scheiner entitled “Applied Cryptography: Protocols, Algorithms And Source Code in C,” published by John Wiley & Sons, 1994, the entirety of which is hereby incorporated by reference. Moreover, more detailed descriptions of systems and apparatus for accomplishing encryption and decryption in computer networks are set forth in U.S. Pat. Nos. 5,903,652, 5,850,442, and 5,850,446, the entirety of each of which is hereby incorporated by reference.

International E-Commerce System, Apparatus and Method of the Present Invention

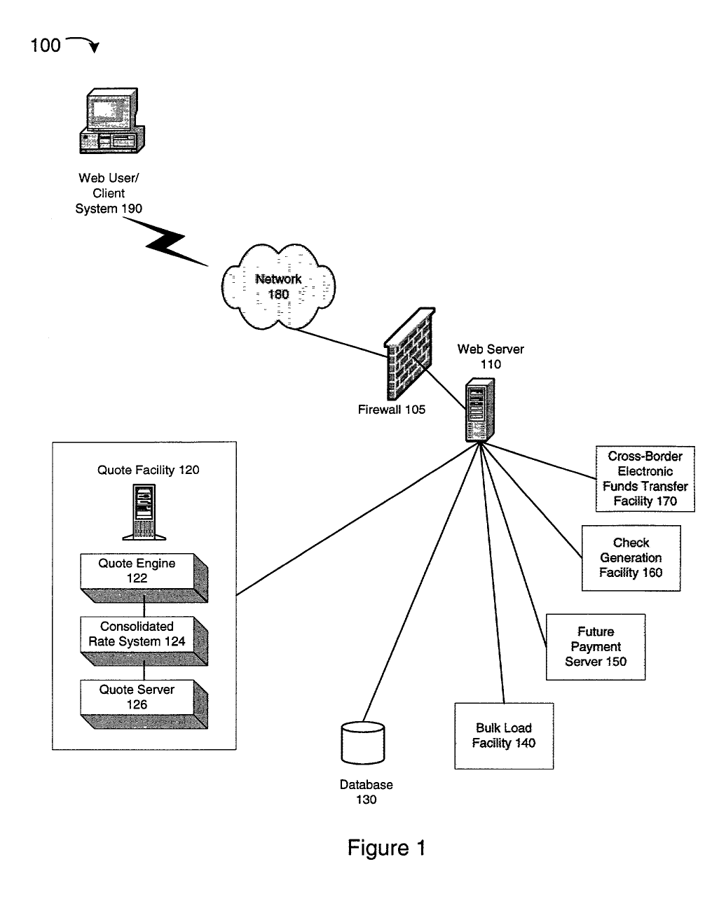

Referring first to FIG. 1, an embodiment of the present invention is illustrated as a system 100. The system 100 includes a web server 110, a quote facility 120, a client database 130, a bulk load facility 140, a future payment server 150, a check generation facility 160, and a cross-border electronic funds transfer facility 170. The web server 110 acts as an interface between the system 100 and a network 180, preferably the Internet, and is preferably isolated from this network 180 by a firewall 105. The web user/client system 190 is representative of a plurality of web users having access to the system 100 via the network 180.

The quote facility 120 preferably includes a quote engine 122 having a quote server 126 and a consolidated rate system (CRS) 124, as will be discussed in detail below.

The system 100 of the present invention is a network-based system, with the web server 110 preferably supporting a web site of the system 100. While the system 100 may be implemented on any network, it is preferably implemented on a public network, such as the Internet.

As a preliminary matter, it is assumed for the purposes of this disclosure that the native currency of users of the system 100 of the present invention is the American dollar. All other currencies will therefore be referred as foreign currencies. Of course, the system 100 is adapted for use by web users having any native currency. In the system 100, it is contemplated that, in addition to the native currency, accounts may be maintained by users of the system 100 in any freely traded foreign currency unit, including but not limited to the Austrian shilling, Australian dollar, Belgian franc, Canadian dollar, Swiss franc, Czech kroner, German mark (Deutschemark), Danish kroner, Spanish peseta, Euro, Finnish markka, Fiji dollar, French franc, British (Sterling) pound, Greek drachma, Hong Kong dollar, Indian rupee, Irish punt, Italian lire, Japanese yen, Korean won, Mexican peso, Dutch guilder, Norwegian kroner, New Taiwanese dollar, New Zealand dollar, Phillipine peso, Portuguese escudo, Saudi riyal, Swedish kronor, Singaporian dollar, Thai baht, Central Polynesian franc, South African rand, and others. In addition, any transactions discussed herein may also be carried out in any of the above or other currencies.

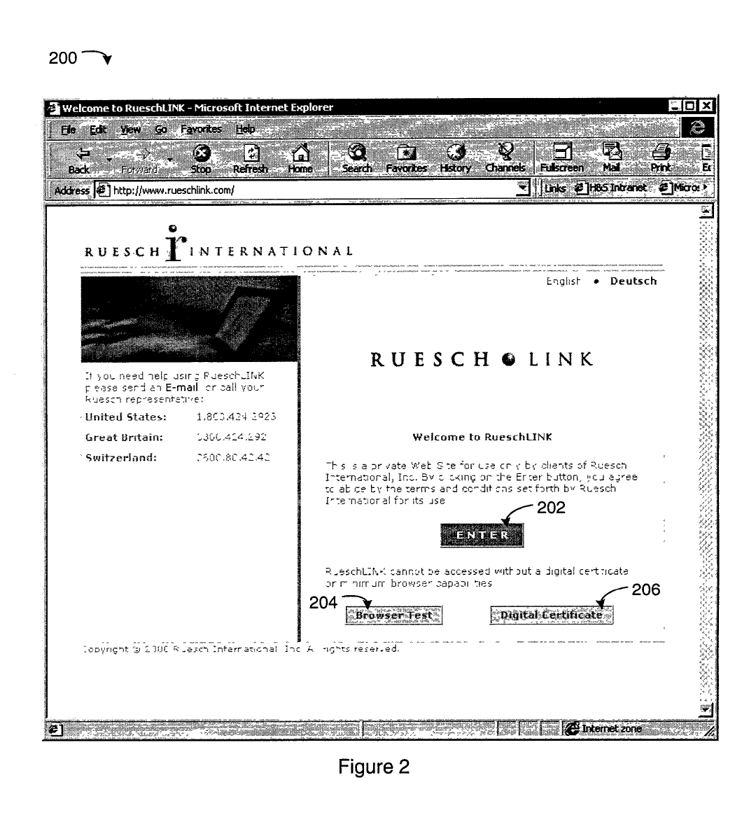

When a user of the Internet wishes to use any of the multiple other features of the system 100, to conduct an international transaction, for example, the web user uses the web user system 190 to connect with the system 100. As will be appreciated by those skilled in the art, the connection will preferably be established between the system 190 of the web user via a network browser installed thereon, and the web site supported by the web server 110. Such a connection occurs when, at the web user's direction, the browser makes an HTTP request for an HTML web page from the web server 110. In return, the web server 110 transmits an HTML web page, preferably a homepage, to the web user's system 190. One embodiment of such a home page 200 is illustrated in FIG. 2. Preferably, before a web user is given full access to the web site of the system 100, the web user will be required to register with the system 100. However, a web user who is already a client, that is, a registered member of the system 100, may proceed immediately to a login process, which is discussed below.

Registration with the system 100 may occur in any of a variety of ways, including online registration, telephone, ground correspondence or other known methods may be used. In light of certain laws and/or governmental regulations, such as foreign asset control regulations, federal law directed against such activities as money laundering, and other constraints, registration conducted via ground correspondence and which includes due diligence, may be preferred, particular in a business-to-business environment. During a registration process, a variety of forms of information may be solicited from a web user, including such demographic information as name, ground address, e-mail address, etc., and financial information. A desired personal login name may also be solicited, or alternatively, be assigned automatically by the system 100. Following any desired approval process implemented at the discretion of an operator of the system 100, the web user will be issued a password and given ‘client’ status in the system 100. Any client-specific information obtained during the registration process will preferably be stored in the client database 130.

In one embodiment, the ‘client’ is a client company or other group entity. Thus, multiple users may be enabled for access by the system 100 for any one client. In such a case, an individual acting as an administrator for the client entity preferably has the authority to add, modify and delete that entity's users of the system, as well as to assign various permissions that permit varied access to functions of the system 100.

Following connection with the system 100 of the present invention, a client may initiate a login process by clicking on ‘enter’ button 202, illustrated on the home page 200 of FIG. 2. The client will then be queried for a login name and password. Note that, prior to logging in, the client may wish to determine the version of the network browser that the client's system is running in order to determine compatibility with the system 100 of the present invention. Thus, in one embodiment, the home page 200 is provided with a ‘browser test’ link or button 204. This link preferably initiates a feature that tests an overall suitability of the client's hardware and software environment, thereby preventing the user from entering the site and potentially discovering problems later.

In addition, due to the financial nature of the present invention, the system 100 may also require a system 190 of the client to be authenticated, and to consequently be capable of secure communications. For example, in a preferred embodiment, a digital certificate is installed on the web server 110 in order to require encryption for secure communications via a Secure Sockets Layer (SSL) between the web server 110 and a system 190 of the client. For authentication of the client system 190, a preferred embodiment of the present invention would also require the issuance of a client digital certificate to the client's system 190. The server 110 may check this certificate to ensure that the client is valid, and that the certificate has not been revoked. In subsequent sessions, authentication of the digital certificate of the client's system 190 could occur at the time of login by the web server 110. Thereafter, secure communications would occur between the client's system 190 and the web server 110 over the SSL with, for example, 128-bit encryption. This encryption provides a desired level of protection for communications such as credit card orders, electronic transfer instructions and other sensitive information. Digital certificates can be obtained from VeriSign, Inc. of Mountain View, Calif., whose web-based system is currently accessible at http://www.verisign.com, or from Baltimore Technologies, with U.S. headquarters in Boston, Mass., whose web-based system is currently accessible at http://ww.baltimore.com, among others. In a preferred embodiment, the system 100 of the present invention provides its own digital certificates, acting as both the Certificate Authority and the Registration Authority for digital certificates, as will be understood by one skilled in the art. For convenience, the home page 200 may be provided with a ‘digital certificate’ button 206. Clicking on this button will preferably lead a client to a site for applying for a digital certificate.

The present invention preferably also allows for other methods for client and user authentication, including but not limited to: smart cards with embedded digital certificates, biometric hardware and software for authentication of such data as finger prints and retinal scan data. Multi-phase authentication, requiring two or more authentication methods, may also be used. For example, software digital certificates simultaneously coupled with retinal scanning hardware and software may be required.

Following authentication and verification of login and certification information, the client will be granted access to the system 100. In a preferred embodiment, different clients will be granted varying degrees of access to the system 100, depending on menu items and functionality, for example, that the particular client has been given permission to access. Preferably, the client will then be presented with a web site main page, or menu page, which provides links to numerous features available from the system 100.

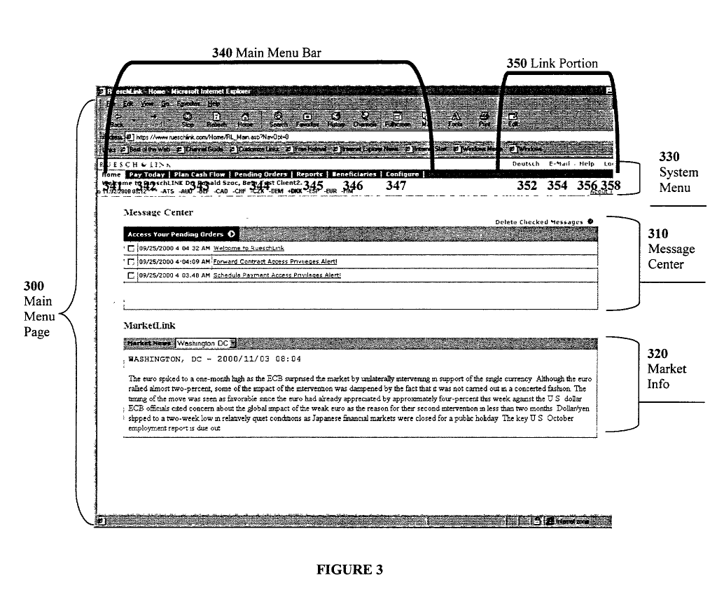

FIG. 3 illustrates an embodiment of a main menu page 300 that preferably appears after a successful login and/or authentication by a client or user. In a preferred embodiment, the main menu page 300 is dynamically and specifically generated for the individual client based on the client's past and future (e.g. scheduled) behavior. In this embodiment, the main menu page 300 includes a message center 310, which shows upcoming events about the client's account, among other information. Examples of these events may include beneficiary payment, purchase into holding, future payment, mature future payment, client forward sale, client forward purchase, mature forward, scheduled payment out of holding, order submitted and/or approved, A/R payment received, debited/credited funds, beneficiary changed and/or added, user added, scheduled payment release expected, forward contracts coming due for payment and delivery, and the like. Additionally, based on the particular client's preferences, the same main menu page 300 may include a market information portion 320 that includes foreign exchange market commentary tailored to a specific currency or country. Preferably, the client is able to choose which events trigger a message to be displayed. In another embodiment, the main menu page 300 is more than a reminder of upcoming events. For example, the page may suggest various foreign exchange risk management strategies based on market volatility, suggest optimal funds replenishment strategies based on an analysis of the client's past actions, and so on.

As shown in FIG. 3, the main menu page 300 may also include a system menu 330 that includes a main menu bar 340 and a link portion 350. The menu bar 340 preferably remains continually visible as a client navigates the various pages of the system 100. In one embodiment, the main menu bar 340 remains visible as a header or a footer, for example, at a top or bottom portion, respectively, on a client's display as a body of the display changes from web page to web page. Any secondary menus that appear after a client chooses a main menu option preferably appear in a group immediately below that main menu item selected. These secondary menus may be context sensitive in that they change depending on a permission level or other characteristics of the client or user.

In a preferred embodiment of the main menu page 300, the link portion 350 includes a language portion, shown as having a Deutsch link 352, an e-mail link 354, a help link 356 and a logout link 358. This link portion 350 may thereby provide to the client one-click access to various features of the system 100. Clicking on the log-out link 358 preferably terminates a connection between a system 190 of the client and the system 100 of the present invention. For security reasons, it is preferable, once a client logs out, that the system 190 of the client be allowed no further access to the system 100 unless the login and certification processes discussed above are repeated. For the same reason, the system 100 preferably has a time-out feature that automatically logs a client out after a predetermined period of web site inactivity.

Clicking on the e-mail link 354 may initiate a default e-mail program on the client's system. A new outgoing message, addressed to an operator or other administrative member of the system 100, will preferably be automatically generated, thereby allowing the client to quickly and easily contact the system 100 by e-mail. The help link 356 preferably links the client to a help page, which may include a list of frequently asked questions and/or other information to assist a client in the use of a web site of the present invention. Additional links providing for additional features may also be provided if desired.

As noted above, the link portion 350 further includes the Deutsch link 352, which allows the user to select a preferred language. In one embodiment, each screen page shown to the user is constructed dynamically in order to take into account the language preference. Language elements, whether as text, or as graphics, are stored in a “language element” database table, and are dynamically placed on the HTML or ASP page based on the current language “mode” that is in effect. This provides several advantages to the user as well as to developers of such systems as that of the present invention. First, by de-coupling the language elements from the HTML pages themselves, additional languages can be added to the system 100 of the present invention with minimal effort. In addition, by dynamically creating the page to be shown to the user, the language can be changed “on the fly” in the middle of a client's session with no loss of information, functionality, or interactive content that the client has supplied. As illustrated, the language portion 350 includes only the Deutsch link 352, but may further include links allowing a client to select as a language preference any other language.

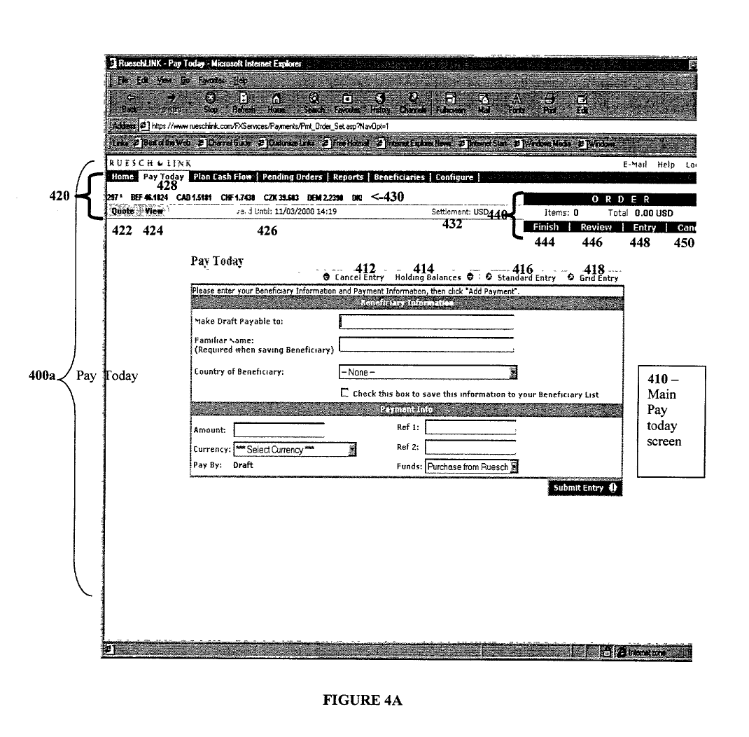

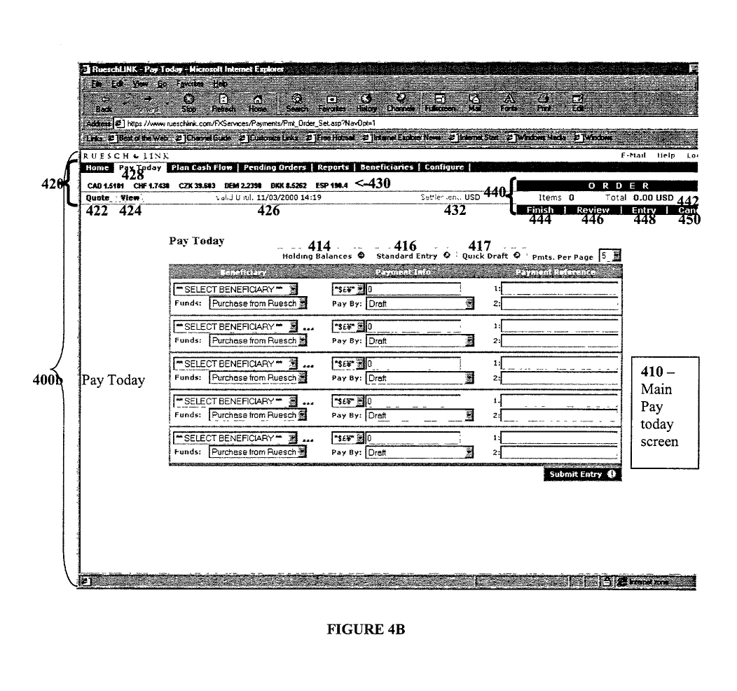

The main menu bar 340 also preferably provides links to various features of the system 100. As illustrated, the main menu bar 340 in this embodiment includes a home link 341, a pay today link 342, a plan cash flow link 343, a pending orders link 344, a reports link 345, a beneficiaries link 346 and a configure link 347. Clicking on the home link 341 from any web page of the system 100 may return a user to the home page 200, the main menu page 300, or any other designated page. Designation of a “home” page may be by an administrator of the system 100, or may be left to the discretion of individual users. Clicking on the pay today link 342 preferably leads a user or client to a pay today page. Embodiments of pay today pages 400a and 400b are illustrated in FIGS. 4A and 4B and will be further discussed below.

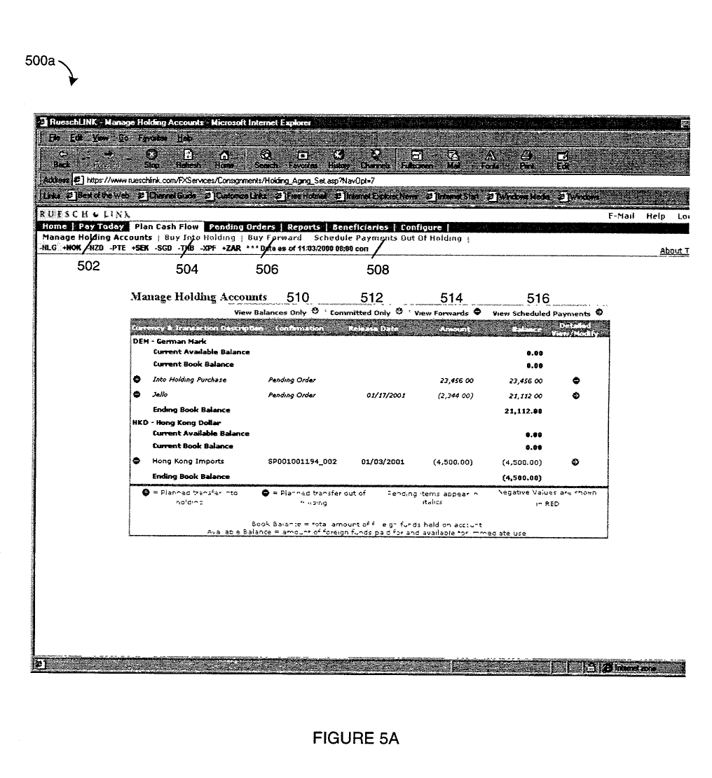

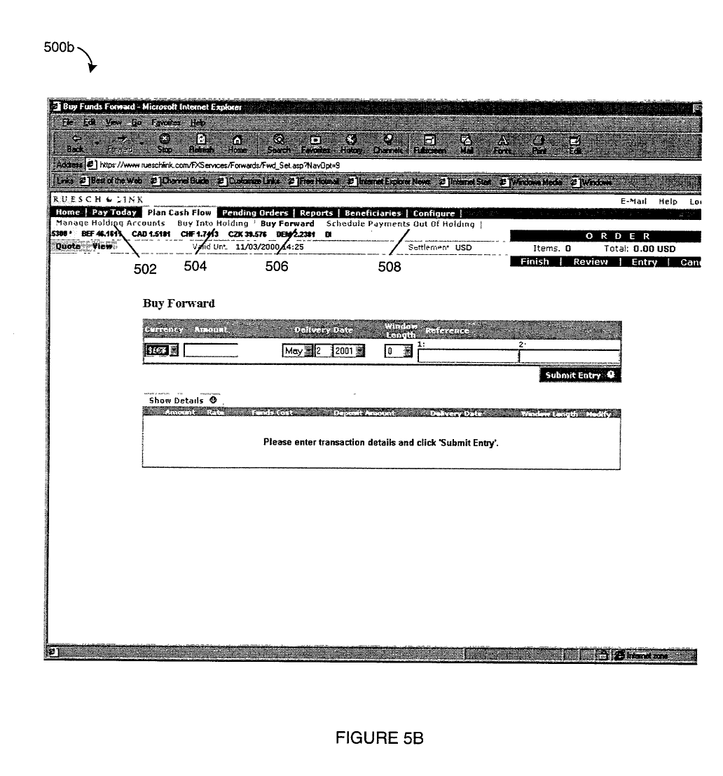

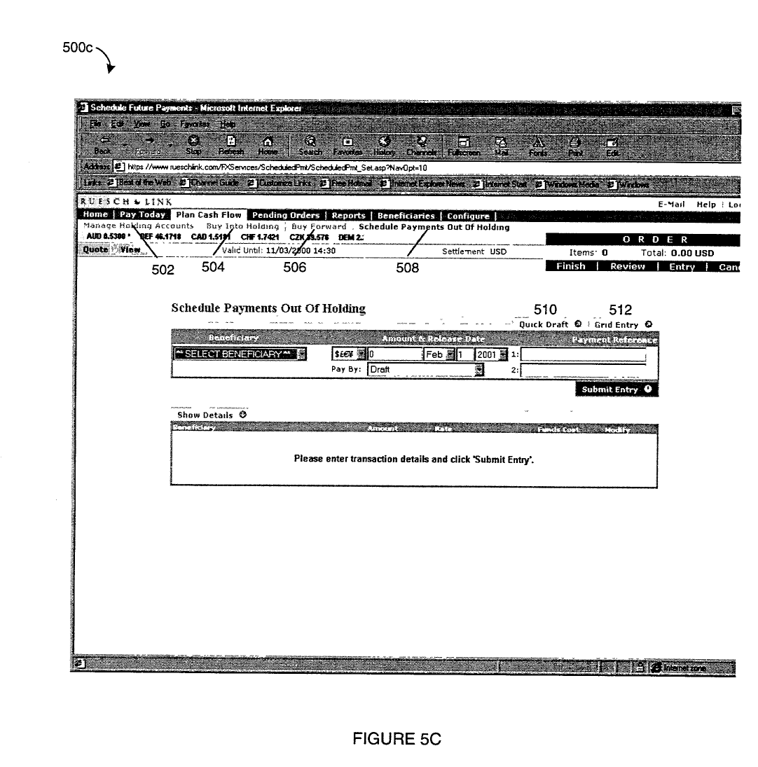

Likewise, clicking on the plan cash flow link 343 preferably directs a client to a cash flow page, from which a client may be able to perform certain actions associated with managing holding accounts, for example. Embodiments of cash flow pages for performing such functions as buying forward and scheduling payments out of holding are illustrated in FIGS. 5A, B and C.

Clicking on the pending orders link 344 preferably presents the client with a page displaying any orders the client has pending. In one embodiment, a pending orders page lists pending orders and includes such information as order numbers, number of orders, initiator of orders and associated time and date of initiation, whether and when orders were approved, etc. Such a page is preferably customizable in accordance with a particular client's preferences.

Activating the reports link 345 preferably leads the client to a reports page, from which a client may initiate a running and/or building of any of a variety of transaction reports. For example, a client may wish to review transactions completed using the system 100 during the past day, week, month, etc. Such reports may be displayed in any of a variety of formats. In one embodiment, a build link provides a client with control over this format by allowing a client to build reports, which may be standard or custom. Upon clicking the build link, the client may be presented with a list of potential reports to be created. For example, reports of beneficiary lists, forward contracts, holding account balances, duplicate payments, etc., may be made available. Once one or more report are selected, a variety of further options are preferably presented for that report, such as title, description, information to be reported, size, position on a page, reporting method, etc.

Clicking on the beneficiaries link 346 preferably leads to a page from which a client can add or modify beneficiary, and initiate present or future payment if desired. The configure link 347 preferably allows a client to modify information relating to the client personally, a client company, beneficiaries, delivery details, etc. These features are further described in detail below.

FIGS. 4A illustrates an embodiment of a pay today menu 400a that may be displayed when a user selects the pay today link 342 of the main menu page 300. As shown, a main entry screen 410 is provided for entering information for drafts to be issued for beneficiaries. The entry screen 410 contains a cancel entry link 412, permitting a client to stop entry with no further liability on the client's part; a holding balances link 414 for examining current book and available balances in holding accounts the client may have; a standard entry link 416 that preferably enables switching between several data entry forms to fit preferences of the client; and a grid entry link 418 that links to a page that provides an alternative form for data entry. An embodiment of such an alternative form is illustrated in FIG. 4B as a grid entry pay today page 400b. As shown, this pay today page 400b provides an alternative form for data entry, includes many of the same features as the first pay today page 400a, and also includes a quick draft link 417 for returning to that form for data entry. Of course, any number of different types of data entry formats may be employed.

With continued reference to FIGS. 4A and 4B, the pay today pages 400a and 400b also include a quotes portion 420 having a quote link 422 and a view link 424, and an order portion 440 including an order information window 442, a finish link 444, a review link 446, an entry link 448 and a cancel link 450. The order portion is further discussed below. In the present embodiment, clicking on the quote link 422 of the quotes portion 420 may direct a client to a separate quotes page having a list of real-time foreign exchange rates for all currencies available on the system 100. Preferably, however, quotes are displayed on the same page, such as in the quotes portion 420. Clicking on the quote link 422 may also automatically perform any calculation then possible. For example, from a pay today page, if an amount in one currency has been entered by the client, clicking on the quote link 422 may calculate a corresponding amount in the relevant currency based on current foreign exchange rates. Preferably, the quotes portion 420 lists in a time portion 426 a time up until which the quotes are guaranteed and may therefore be relied upon by the client. A time when the quotes were issued may also be displayed, if desired. In a preferred embodiment, quotes are guaranteed for a period of ten minutes, but this period may be as long or as short as an operator of the system 100 desires, and may differ between different clients. The use of quotes by a client will be discussed in greater detail below.

As discussed, the quote portion 420 preferably further includes quote information areas 426 and 432, and a scrolling quote bar 430. The quote portion 420 relates to information regarding foreign exchange rate quotes. The system 100 of the present invention offers quotes of foreign exchange rates through the quote facility 120 of FIG. 1. Cross rates, i.e. rates of currencies with respect to other currencies, are also preferably provided. When a client clicks on the quote link 422, the web server 110 sends a request to the quote engine 122 of the quote facility 120. The quote engine 122 is preferably a component object model (COM) and a protocol. The protocol is a set of stored procedures residing in, for example, a structured query language (SQL) server database. The quote engine 122 retrieves current, or spot, foreign exchange rates and forward points or forward rate quotes. Alternatively, the quotes may be derived from any or all of these quotes, as discussed below. This and other real time financial data may be self-gathered by the system 100, but is preferably obtained via a live feed from an outside source, such as Reuters Group, PLC, of London. In addition, while the quote facility 120 is described as a part of the system 100, it is contemplated that the quote facility 120, or portions thereof, may be de-coupled from the system 100 and used to provide a real-time quoting service independent of the facilitation of a commercial transaction. Users may simply use it as a pricing estimator.

The quote engine 122 then processes the spot rates received in accordance with a plurality of parameters to derive a rate or rates to be quoted. The parameters considered may include current market spot rate; whether the transaction to which the rate is to be applied is a buy, sell, spot transaction, forward transaction, etc.; a client rate structure, e.g. various spreads based on the particular client; currency cushion; and others. That is, a rate and/or rate cushion may be determined in a variety of ways. In one embodiment, a rate cushion is dynamically variable based on any number of market and exogenous factors, and can be modified on a per client basis as well as system-wide. For determination of a forward rate to be quoted, market information such as native and foreign interest rates are preferably also considered in conjunction with a spot exchange rate. In one embodiment, forward points are added to the spot rate. The forward rate may then be presented in a form of a simple foreign exchange rate, or in a form of a ‘spot related’ rate with additional points, for example.

Note that spread feature discussed above is preferably optional, and is provided in order to provide a potential revenue stream for an operator of a system 100 of the present invention. If no such revenue stream is desired, then a spread may be zero, i.e. no spreads need to be applied. In another embodiment, the spread represents the risk and uncertainty of cross-currency transactions taken on by the operator of the system 100, and would thus result in no risk being maintained by either party to the corresponding transaction. By altering these spreads, risk and uncertainty can be shared to varying degrees between a client, vendor, and third party providing payment services. Alternatively, a transaction may be a ‘fulfillment transaction’ that does not involve any rates at all. For example, a client may have purchased funds into holding at some prior time and is merely providing instructions for disbursement of those funds.

Further information considered in generating a rate quote may be stored in the consolidated rate structure 124. The consolidated rate structure 124 is a database that preferably holds such client-specific information as a given spread for each client and a history of rate quotes given to each client and the subsequent disposition of those quotes, i.e. whether the client executed or scheduled a transaction using each quote. The spread assigned to each client provides a measure of a modifying of spot exchange rates that occurs prior to a rate being quoted to the client. For example, a spread may be zero, whereby a client will be quoted the spot rate, or any positive or negative value, indicating that a spot rate should be increased or decreased.

In one embodiment, a possible optimization of the quote engine 122 of the present invention described herein would be to build in any number of business rules to make the setting of spreads dynamically and automatically sensitive to market conditions such as market volatility (defined herein as the range of rate fluctuation along with the speed or frequency of rate fluctuation), payment patterns on the part of the client, and other factors in order to manage risk and/or enhance profitability.

Another possible embodiment of the optimization described above would be to extend the business rules to the domain of business objectives, so that the spreads would be dynamically adjusted to perform any or all of the following: enhance profitability for the seller of the payment instruments; reduce the cost and complexity of payments to the client; and take advantage of brief foreign exchange market disparities and allow the rates quoted to ‘lag’ the direction of the market. Note that this is different from many known systems in that neither party to the transaction assumes any risk, and in that each party has full control of what each wishes to do. For example, a vendor gets the desired price and a consumer pays a desired price. Rather, the risk is maintained by the system 100.

The processing of the above-described parameters and information by the quote engine 122, including data stored in the consolidated rate structure 124, is preferably controlled by a software application. Flexibility offered by such a software application would allow stored parameters to be modified real-time, and in a variety of capacities. For example, a rate structure may be altered for one or multiple clients, temporarily or permanently, with respect to one or multiple currencies, etc.

Following any desired exchange rate processing, the quote server 126 preferably sends the modified rate quote information back to the web server 110. Under control of the software application, the quote information may be immediately displayed to the client. Alternatively, the quote information may be forwarded to staff members of the system 100, who then provide the quote information to clients.

Referring again to FIGS. 4A and 4B, the scrolling quote bar 430 provides a scrolling list of the foreign exchange rates received by the web server 110 from the quote server 126. Rates are displayed for various currencies with respect to the currently logged-in client's native currency. The scrolling quote bar 430 is preferably customizable at a discretion of the client, whereby the client may change the number of rates displayed, the manner in which they are displayed, the client's native currency, etc. While the scrolling quote bar 430 may display realtime, constantly-changing rates, it is preferable that the displayed quoted rates are updated at a request of the client, such as by clicking on the quote link 422. Preferably, the results in the display thereafter remain constant for a period of time, notwithstanding potential market-related shifts in exchange rates that may occur. Note that clicking on the view link 424 may lead to display of the same quotes in a different format, such as, in one embodiment, a static page that opens in a new browser window.

As an illustrative example of a use of real-time quotes, reference is made to the quote rates being displayed in the scrolling quote bar 430. According to the quote information area 426, the rates quoted are valid until Nov. 03, 2000 at 2:19PM. In this manner, once the client receives the rate quotes, the client has a period of time to conduct a market transaction, such as buying foreign currency, paying beneficiaries or otherwise fulfilling an obligation, etc. For example, if the client clicks on the pay today link 428 of FIG. 3, discussed below, the system 100 will dynamically price a selected transaction based on the currently displayed rate quotes, assuming the period for which the quotes are valid has not yet expired. For reference, the quote information area 432 displays a settlement currency, illustrated here as the United States dollar (USD).

The order portion 440 includes an order information window 442, a finish link 444, a review link 446, an entry link 448 and a cancel link 450. A client preferably initiates a payment process by clicking on the entry link 444. A client may preferably review entered orders by activating the review link 446, and may cancel orders that have been entered but not transacted by clicking on the cancel link 450. Preferably, a client may cancel any order that has not been carried out without incurring any liability as a result.

In the embodiment of the present invention illustrated by FIGS. 3, 4A and 4B, links are provided to various financial information and features available from the system 100 of the present invention. One of these links, the plan cash flow link 343, preferably directs a client to a page containing, among other things, financial information relating to client accounts such as holding accounts. The system 100 provides one or more holding accounts to its clients where the clients may maintain funds in foreign currencies. A client may buy foreign currency for the accounts, where it is held until disposed of by the client. The client may dispose of foreign funds by making a payment, such as by draft or electronic funds transfer, or by selling the currency back to the system 100. Preferably, electronic payments will be processed by a facility such as the cross-border electronic funds transfer facility 170.

Holding accounts provide numerous advantages to a client. Because clients are able to aggregate several sources of payments and cash flow over time, clients may then schedule larger payments out at later date. When scheduling funds forward, clients can automatically receive funds forward, and can schedule payments out of holding based on funds that will be delivered in at some future point in time. In one embodiment, clients may be enabled to schedule payments out of holding even when the client has no current funds in any holding accounts. The client can then ‘feed’ the holding account using a variety of methods, such as selling incoming foreign funds into holding from outside sources, purchasing funds into holding, or ordering funds forwards. The payment will be released only if there are sufficient funds in the corresponding holding account. This is advantageous to the client in that the client gets more control over the client's cross-border accounts and payable cash flow. This feature also allows the client to cast ‘what if’ scenarios and examine various cash management strategies. The client can further use foreign exchange market information to time the feeding of the holding accounts to either minimize risk and/or maximize profit.

In one embodiment, clicking on the plan cash flow link 343 of FIGS. 4A and 4B directs a client to any of a variety of cash flow pages, as illustrated in FIGS. 5A, 5B and 5C. These pages preferably provide additional links to other cash flow pages as well. As shown on the variety of cash flow pages 500a, 500b and 500c, these links may include a manage holding accounts link 502, a buy into holding link 504, a buy forward link 506 and a schedule payments link 508, for scheduling payments out of holding. Preferably, these cash flow pages are specific to the currently logged-in client. There, the client can view a list of the holding accounts the client currently has open, and the funds available in each account.

Clicking on the manage holding accounts link 502 may direct the client to a manage holding accounts page 500a. As shown in FIG. 5A, the manage holding accounts page 500a includes such links as a view balances link 510, for viewing holding accounts balances; a committed link 512, for determining if funds have been slated for transfer out, for example; a view forwards link 514, for viewing forwards; and a view scheduled payments link 516, for viewing any scheduled payments from the client's account.

If a client wishes to open a new holding account, or buy currency into an existing holding account, the client preferably indicates such by clicking on the buy into holding link 504. The client will preferably be presented with a web page adapted to allow entry of information relating to a desired holding account. For example, the client may simply enter an amount and a foreign currency. The system 100 will preferably automatically establish an account and deduct the appropriate funds, based on a current exchange rate, from the client's native currency account. If an exchange rate had previously been quoted, and had not yet expired, that exchange rate would be applied. In one embodiment, a client may create a ‘what if’ scenario at any time, for illustrative purposes, with no commitment on the part of the client to the foreign exchange supplier.

If a client wants to buy funds forward, the client preferably clicks on the buy forward link 506, which may present to the client a page such as the buy forward page 500b. From this page 500b, the client may specify a currency and amount, and a desired delivery date, for funds to be purchased forward.

Similarly, when a client desires to schedule payments out of holding, the schedule payments link 508 may be used to access a schedule payments page 500c. From this page 500c, the client may select a currency, amount and release date, and a desired beneficiary. Options for differing data entry formats may be provided, such as by a quick draft link 510 and a grid entry link 512.

Referring again to FIG. 3, the beneficiaries link 346 and associated processes of adding and modifying beneficiaries and/or making or scheduling payments to beneficiaries will now be described. As noted above, the order portion 440 of FIG. 4A or 4B includes an order information window 442, a finish link 444, a review link 446, an entry link 448 and a cancel link 450. A client preferably initiates a payment process by clicking on the entry link 444. As is discussed below, a client may also add a beneficiary and schedule a payment in the same step or series of steps. Alternatively, for a client viewing the main menu 300 of FIG. 3, the client may initiate a current payment process by clicking the pay today link 342, for example. In one embodiment, the future payment server 150, discussed above, carries out any processing of such future payments. Typically, future payments will take the form of a forward contract, in which a current exchange rate is locked in for a transaction to be executed in the future.

For a client who has not yet designated beneficiaries, or who desires to add additional beneficiaries, an option to add beneficiaries is preferably provided. This option may be available from a page reached by clicking on the beneficiaries link 346. Typically, the list should include beneficiaries that the client regularly makes payments to or intends to make payments to in the future. As will be appreciated by one skilled in the art, the beneficiary process may be as simple as completing a web page form adapted for submission of any of a variety of forms of information. For example, a client may be queried for information such as beneficiary name, country, native currency, reference/delivery information, acceptable form(s) of payment, etc. This information may be updated or modified at any time without making a payment.

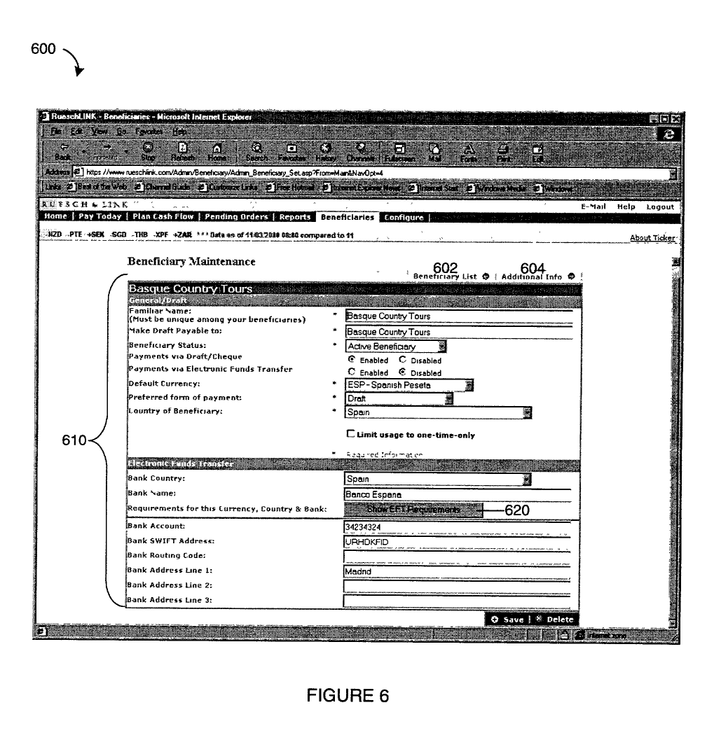

In one embodiment, selecting a beneficiary from a list of beneficiaries, or alternatively, selecting an add link to add a new beneficiary, leads to display of a beneficiary maintenance page. An embodiment of such is illustrated as a beneficiary maintenance page 600 in FIG. 6. From this page 600, the client may return to a main list by clicking a beneficiary list link 602, or may give or receive more information by clicking an additional info link 604. Or, from a data entry portion 610, the client may add or modify such beneficiary information as shorthand or familiar name, ‘payable-to’ or official name, beneficiary status; may designate whether draft or check payment and/or electronic funds transfer (EFT) payment will be allowed for the beneficiary; select a default currency and preferred form of payment; designate a country of the beneficiary; and others.

For EFT-enabled beneficiaries, the data entry portion 610 may also allow for entry of EFT information, such as bank country and name, requirements, account and routing information, routing address, etc. Preferably, a show EFT requirements button or link 620 is further provided here. This feature provides the system 100 of the present invention with a built-in intelligence with regard to EFT requirements of each country to which an EFT is made, through which the system 100 is able to verify and validate users' inputs to ensure compliance with the requirements. This feature also preferably provides on-screen descriptions of what is required if requested by a user.

In another embodiment, a client may add a beneficiary directly as part of an order, rather than through a separate ‘add beneficiaries’ step. The beneficiary may then optionally be saved, giving the client the freedom and flexibility of ‘delayed binding’ of this information. The system 100 may also include the bulk load facility 140 of FIG. 1. As discussed below, the bulk load facility 140 greatly facilitates the entry of beneficiaries and associated payment orders.

Upon clicking the add beneficiaries link (not shown) or the pay beneficiaries link 346, a client will preferably be presented with a web page that includes a list of previously entered beneficiaries and associated payments. Clicking on the pay today link 342 or the plan cash flow link 343 may also lead to options for similar pages, such as the schedule payments page 500c, if desired. Regardless, a transaction may be scheduled for present or for any future time. In each case, the payments referred to may be periodic payments to respective beneficiaries, or may be one-time transactions. For example, a selected transaction may designate a present or future payment to a foreign beneficiary, in a certain amount. At this time, the client may also add additional payments or other transactions if desired. A client also preferably designates a form of payment at this time. While orders may be executed in any known manner, it is preferable that the client select between foreign drafts, which may be drawn on foreign banks using a currency associated with the transaction, or electronic funds transfers.

In another embodiment, clicking on the add beneficiaries link, the beneficiaries link 346, the quick draft link 417, etc., leads to a ‘quick payment’ page. In this embodiment, alternative functionality may be provided. For example, the client may be presented with a ‘holding balances’ button, allowing the client to display foreign funds balances available in various holding accounts in a secondary window while viewing the order entry page. Preferably, the balances displayed are ‘available balances’ rather than ‘book balances,’ such that the client can learn the limits to the amounts that can be taken out of holding. In an embodiment where both of the above order options are available, the client may further be presented with a ‘change entry’ option. This option allows the client to change entry modes on the fly, while entering an order, with no information being lost, thereby providing a dynamically configurable view in which the entered information is de-coupled from a method of presentation.

In yet another embodiment of the present invention, the system 100 of the present invention may provide for an optional multi-tier approval process, whereby one user may enter an order and provisionally commit to the order. The order is then held in a pending state, until another client or user of the system 100, one with greater authority for example, gives final approval for commitment for the order. Preferably, there is no limit in the system as to the number of hierarchical approvals that are necessary to authorize the transaction, and no limit to the time required for those authorizations to be given. This feature takes into account the typical internal authorization flows within large and more complex organizations.

In still yet another embodiment of the present invention, a client is able to enter not only present transactions and transactions set to execute at a specific time, but also transactions that will execute only when and if a specific foreign exchange rate is available. These limit transactions, or standing orders, are entered in the same manner as the present and future orders discussed, with the exception that a client must also enter a desired exchange rate. If the desired rate is achieved, the transaction will execute. Otherwise, the transaction may be set to expire after any passage of any chosen period of time.

Once one or more beneficiary payments have been scheduled, a client may review them by clicking on the pending orders link 344 of the main menu bar 350 or on the review link 446 of the order portion 440 of the menu bar 410, for example. One or more of the payment options may then be selected, as an indication by the client of a desire to execute the selected transaction or transactions. As discussed below, the client may chose to execute a transaction following receipt of a favorable exchange rate quote with respect to the transaction. As long as an exchange rate quote has not yet expired at a time of execution of a transaction, the transaction will receive the benefit of that rate quote.

In each of the above embodiments, it is possible for a client to enter all details of a payment or order, but not commit it for processing. This allows the client to mark the order as ‘pending.’ The client may then go into the system 100 of the present invention at any time, and price the pending order by clicking on a link, such as one labeled ‘re-price,’ for example. The client could then commit, cancel or leave the order pending. Thus, the client may use the system 100 as a ‘scratch pad’. This feature places the client in complete control, and provides the client with access to immediate knowledge of the costs that the client would incur upon commitment of the order. As will be appreciated by one skilled in the art, this feature for making transactional elements pending may also be used in broader contexts that foreign exchange and/or global payments. For example, the present invention may be generalized to include any purchase item, such as commodities including stocks, bonds, physical inventory used in manufacturing, etc., services, and others.

Following selection of one or more transactions for execution, the system 100 may then optionally proceed to a type of financial confirmation page, as will be appreciated by one skilled in the art. Such a confirmation page is preferably designed to give a client a final opportunity to review all transactions, modify transaction as desired, or cancel transactions before they are irreversibly executed. The page may include any or all details of each transaction, including applicable foreign exchange rate, anticipated account balance, form of payment (e.g., draft, electronic funds transfer, etc.), service charge, or others. When a client is satisfied with a status of all orders, verified any delivery and notification information, etc., the order or orders will be executed.

Through use of the real-time foreign exchange quote and payment scheduling features of the system 100 of the present invention, clients can realize significant advantages in the execution of foreign transactions. In light of constantly varying foreign exchange rates, a timing of foreign transactions, particularly those involving large sums of money, can have a marked effect on economic impact to clients. The availability of real-time exchange rate quotes allows a client to constantly monitor the status of the market. Additional features of the present invention, discussed below, further assist in predicting future market behavior.

As mentioned above, the present invention preferably uses the bulk load facility 140. The bulk load facility 140 allows clients to upload beneficiary and associated payment information in a markup page format, such as hypertext markup language (HTML), extensible markup language (XML), etc. The format will be read, and the desired transactions automatically generated and priced. In this manner, the bulk load facility 140 can be an advantageous feature, particularly to clients having a large number of payments, or who simply prefer to upload payment information electronically. Alternatively, clients may enter information for beneficiaries one at a time, but need not store beneficiary information at all. Order information may be entered as part of an order itself, with the information either being retained or not retained at the client's option.

As discussed above, the main menu bar 340 further includes a configure link 347. The configure link 347 preferably leads to a further page having a variety of user information and preference options. For example, the configure link 347 preferably allows a client to submit personal or company information to the system 100. This information may include contact information, quote and payment preferences, etc. Options to add to or modify a user account may allow a client to set up a client account for more than one user. For example, a corporate client may wish to grant access to any or all of its employees. The configure link 347 may also lead a client to an option to select which alerts related to the client's account will trigger various messages in a message center 310, as was discussed above with respect to FIG. 3.

Beneficiary options are preferably further provided that allow for an addition or deletion of beneficiaries from a stored list of beneficiaries. When a client elects to schedule a payment, for example, such a list of beneficiaries may be used to give the client a list of potential recipients of the payment. Also, the configure link 347 may provide another option where the client may modify such information as delivery instructions in the system 100. The delivery method may relate to orders or drafts, for example, and may include ground service, overnight air mail, 2-day service, etc. Delivery and/or pickup locations may also be modified. Countless other options are contemplated, as will be appreciated by one skilled in the art.

The present invention may further be provided with a market link portion having such links as an overview link, a profile link, and others providing to clients access to certain market-related and other financial information. The information may be raw currency data, or may include news-related items or other forms of information useful in predicting future market behavior. The overview link preferably provides a summary of recent economic and financial events. Included may be a list of market highlights for the future. The profile link preferably includes more specific market information directed to any one of the plurality of currencies traded throughout the system 100. Other related links are contemplated as well.

In another aspect of the present invention, a feature is provided for foreign draft or check printing. Because the system 100 of the present invention is involved in the buying and selling of foreign currency, it is advantageous to have the ability to issue on demand drafts that are acceptable in the country, and associated financial institution, from which they are drawn. These drafts are preferably issued at a time a client's order is processed.

Different banks or other financial entities have different requirements with respect to size and other format-related features of drafts. These requirements include typeface or font, and field positioning of account numbers and sort codes (for example, E13B, CMC7, OCR-A, etc.), among other requirements. Conformance to such requirements may be necessary so that automatically produced drafts may be cleared by automated check clearing equipment of countries on which the drafts are drawn. In one embodiment of a method of the present invention, the system 100 preferably first receives a sample draft, illustrating the requirements, from each financial entity with which financial transactions are desired. Specifically, sample drafts are preferably received from banks in countries with which the system 100 is associated. These sample drafts may then scanned and digitized, and stored on a machine-readable medium. Sample drafts, or other means, may also be used to determine and replicate such features as magnetically and optically encoded areas in accordance with requirements.

Images resulting from the scans may then be field-encoded such that fields for party, amount, date, etc., may be altered for individual drafts while maintaining conformance with formatting restrictions. In addition, once scanned, the draft images may be adjusted for printing on stock paper of varying sizes as required by the banks or other entities. If desired, sample drafts may be printed and cleared for acceptability by the relevant parties. In one embodiment, necessary processing for the check or draft feature of the present invention is carried out by the check generation facility 160 of FIG. 1.

Once the draft images have been stored and cleared, drafts may advantageously be printed one or more at a time on demand. Furthermore, by using the digitized forms of the drafts, the drafts may be customized or otherwise modified, such as through the addition of logos or other designs specific to individual clients.

Implementation

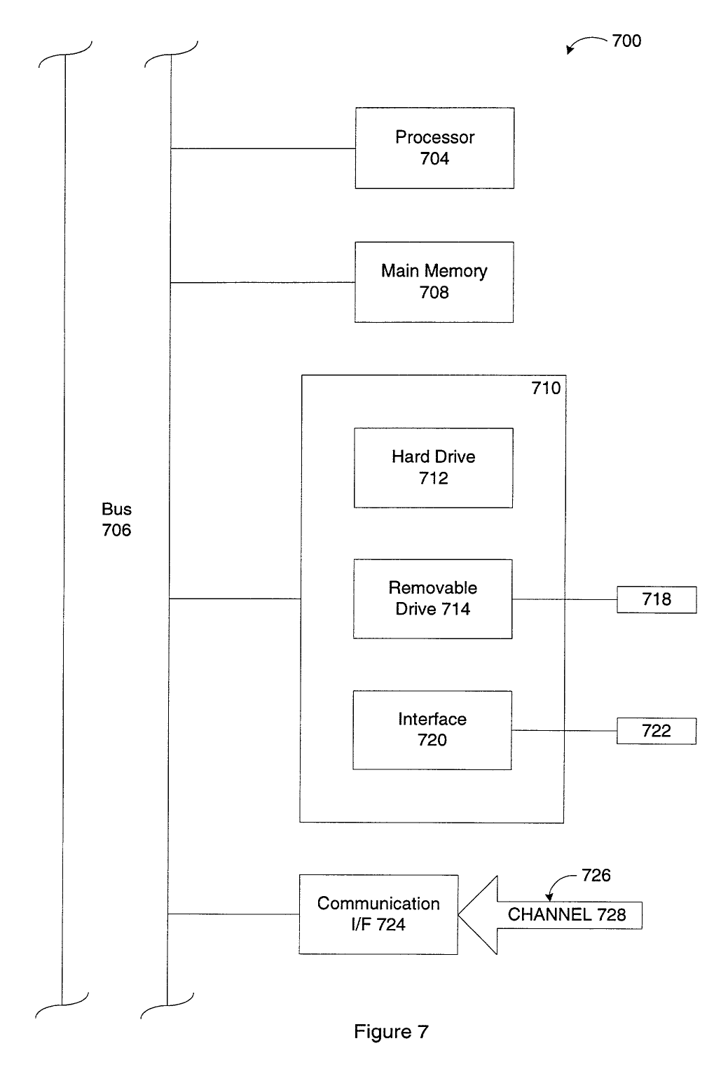

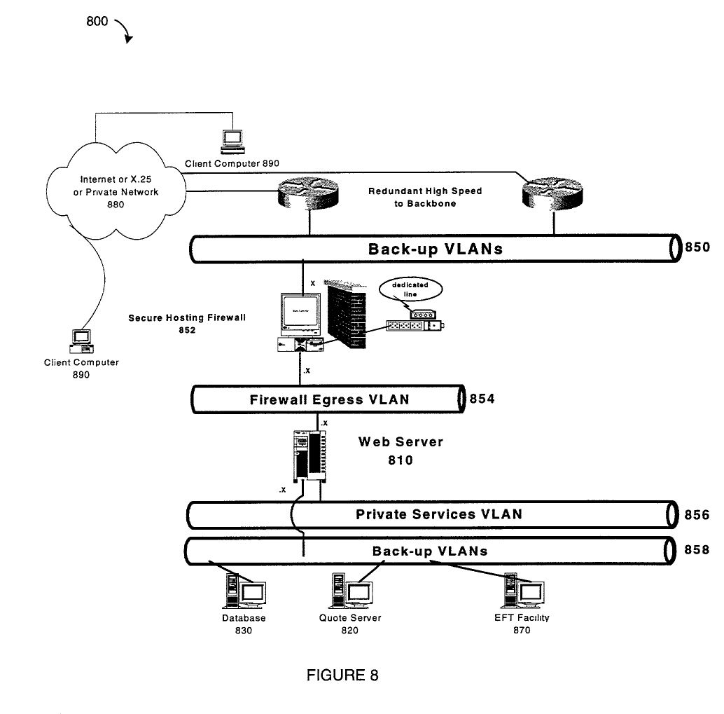

An embodiment of a computer system 700 and an embodiment of an associated network 800 capable of carrying out the functionality described herein are shown in more detail in FIGS. 7 and 8, respectively. The computer system 700 includes one or more processors, such as a processor 704. The processor 704 is connected to a communication bus 706. Various software embodiments are described in terms of this exemplary computer system. After reading this description, it will become apparent to a person skilled in the relevant art how to implement the invention using other computer systems and/or computer architectures.

The computer system 702 also includes a main memory 708, preferably random access memory (RAM), and can also include a secondary memory 710. The secondary memory 710 can include, for example, a hard disk drive 712 and/or a removable storage drive 714, representing a floppy disk drive, a magnetic tape drive, an optical disk drive, etc. The removable storage drive 714 reads from and/or writes to a removable storage unit 718 in a well-known manner. The removable storage unit 718, represents a floppy disk, magnetic tape, optical disk, etc. which is read by and written to by the removable storage drive 714. As will be appreciated, the removable storage unit 718 includes a computer usable storage medium having stored therein computer software and/or data.

In alternative embodiments, the secondary memory 710 may include other similar means for allowing computer programs or other instructions to be loaded into the computer system 702. Such means can include, for example, a removable storage unit 722 and an interface 720. Examples of such can include a program cartridge and cartridge interface (such as that found in video game devices), a removable memory chip (such as an EPROM, or PROM) and associated socket, and other removable storage units 722 and interfaces 720 which allow software and data to be transferred from the removable storage unit 722 to the computer system 702.

The computer system 702 can also include a communications interface 724. The communications interface 724 allows software and data to be transferred between the computer system 702 and external devices. Examples of the communications interface 724 can include a modem, a network interface (such as an Ethernet card), a communications port, a PCMCIA slot and card, keyboard, pointing device such as a mouse or track ball, voice activated synthesizer, infra-red connection, etc. Software and data transferred via the communications interface 724 are in the form of signals 726 that can be electronic, electromagnetic, optical or other signals capable of being received by the communications interface 724. Signals 726 are provided to communications interface via a channel 728. A channel 728 carries signals 726 and can be implemented using wire or cable, fiber optics, a phone line, a cellular phone link, an RF link and other communications channels.

In this document, the terms “computer program medium” and “computer usable medium” are used to generally refer to media such as the removable storage device 718, a hard disk installed in hard disk drive 712, and signals 726. These computer program products are means for providing software to the computer system 702.

Computer programs (also called computer control logic) are stored in the main memory 708 and/or the secondary memory 710. Computer programs can also be received via the communications interface 724. Such computer programs, when executed, enable the computer system 702 to perform the features of the present invention as discussed herein. In particular, the computer programs, when executed, enable the processor 704 to perform the features of the present invention. Accordingly, such computer programs represent controllers of the computer system 702.

In an embodiment where the invention is implemented using software, the software may be stored in a computer program product and loaded into the computer system 702 using the removable storage drive 714, the hard drive 712 or the communications interface 724. The control logic (software), when executed by the processor 704, causes the processor 704 to perform the functions of the invention as described herein.

In another embodiment, the invention is implemented primarily in hardware using, for example, hardware components such as application specific integrated circuits (ASICs). Implementation of such a hardware state machine so as to perform the functions described herein will be apparent to persons skilled in the relevant art(s).

In yet another embodiment, the invention is implemented using a combination of both hardware and software.

As illustrated in FIG. 8, the network 800 includes a server-side web server 810, quote server 820, database 830 and electronic funds transfer (EFT) facility 870 in communication with one or more client computers 890 over a network 880. The web server 810 may be interfaced with the quote server 820, database 830 and the EFT facility 870 via a private services virtual local area network (VLAN) 856 and/or back-up VLANs 858. The VLANs preferably allow separation of independent streams of data traffic through the system. Firewall protection may further be provided for security via a secure hosting firewall 852, optionally having a dedicated line, and a firewall egress VLAN 854. One or more additional back-up VLANs 850 may act to interface the web server 810 with the one or more client systems or computers 890.

Conclusion

While various embodiments of the present invention have been described above, it should be understood that they have been presented by way of example only, and not limitation. For example, the present invention is not limited to the physical arrangements or use with any particular network. The illustrated web pages and associated links and functionality are exemplary, and may be subject to rearrangement, modification, deletion, addition, etc., within the scope of the present invention. In addition, single or multiple portions of the present invention, whether physical or conceptual, may be de-coupled and used independently, such as in any of a variety of business-to-business or business-to-consumer settings. As such, the breadth and scope of the present invention should not be limited to any of the above-described exemplary embodiments, but should be defined only in accordance with the following claims and their equivalents.

What is claimed is:

1. A method for providing a foreign exchange rate quote to a client over a public network, comprising:
obtaining a current rate from a quote source;
accessing secondary information;
calculating a modified rate quote based on the current rate and the accessed secondary information; and
providing the modified rate quote to the client.

2. The method of claim 1, said accessing comprising:
accessing client-specific information

3. The method of claim 2, wherein said client-specific information includes a predetermined spread assigned to the client.

4. The method of claim 2, wherein said client-specific information includes a transaction history of the client.

5. The method of claim 1, said accessing comprising:
accessing rate-specific information.

6. The method of claim 5, wherein said rate-specific information includes a predetermined currency cushion based on a national origin of a currency to which the foreign exchange rate quote relates.

7. The method of claim 5, wherein said rate-specific information includes a foreign interest rate.

8. The method of claim 1, said accessing comprising:
accessing transaction-specific information.

9. The method of claim 8, wherein said transaction-specific information includes information indicating a nature of a transaction for which the foreign exchange rate quote is provided.

10. The method of claim 9, wherein said transaction-specific information indicates whether the transaction is any of a buy, a sell, a spot transaction or a forward.

11. The method of claim 10, wherein when the transaction is a forward, said method further comprises:
adding forward points to said calculated modified rate quote.

12. The method of claim 1, said accessing comprising:
accessing at least two of client-specific, rate-specific and transaction-specific information.

13. The method of claim 1, further comprising:
defining a period of time during which the modified rate quote will be valid.

14. The method of claim 13, further comprising:
calculating a settling rate for a transaction based on the modified rate quote in response to a request for the same by the client during the defined period of time.

15. The method of claim 1, further comprising:
receiving a request for a quote from the client.

16. A method for generating a draft conforming to requirements of any of a plurality of financial centers, comprising:
receiving from a financial center a sample draft;
determining from the sample draft a set of draft requirements;
storing electronically the set of draft requirements; and
producing a draft based on the stored set of draft requirements.

17. The method of claim 16, wherein the set of draft requirements includes at least one of draft size and draft format.

18. The method of claim 16, further comprising:
modifying the stored set of draft requirements based on client-specific information.

19. The method of claim 18, wherein the client-specific information includes a client logo.

20. The method of claim 18, wherein the client-specific information includes at least one of a party, draft amount and date for an individual draft.

21. A method for scheduling international transactions for a client, comprising:
transmitting real-time foreign exchange rate information to the client;
receiving from the client an order for a plurality of transactions to be conducted in a plurality of currencies, the plurality of transactions being based on the transmitted foreign exchange rate information;
scheduling execution of at least one of the plurality of transactions; and
arranging for billing of the client upon execution of the at least one of the plurality of transactions in a native currency of the client;
wherein the at least one of the plurality of scheduled transactions is to be executed with respect to any of a number of beneficiaries previously designated by the client.

22. The method of claim 21, wherein the at least one of the plurality of transactions is to be conducted in a currency different from the native currency of the client.

23. The method of claim 21, further comprising:
executing the at least one of the plurality of transactions; and
billing the client, upon execution of the at least one of the plurality of transactions, in a native currency of the client.

24. The method of claim 21, further comprising:
canceling the at least one scheduled transaction without imparting any associated liability to the client.

25. An apparatus for providing a foreign exchange rate quote to a client over a public network, comprising:
means for obtaining a current rate from a quote source;
means for accessing secondary information;
means for calculating a modified rate quote based on the current rate and the accessed secondary information; and
means for providing the modified rate quote to the client.

26. An apparatus for generating a draft conforming to requirements of any of a plurality of financial centers, comprising:
means for receiving from a financial center a sample draft;
means for determining from the sample draft a set of draft requirements;
means for storing electronically the set of draft requirements; and
means for producing a draft based on the stored set of draft requirements.

27. An apparatus for scheduling international transactions for a client, comprising:
means for transmitting real-time foreign exchange rate information to the client;
means for receiving from the client an order for a plurality of transactions to be conducted in a plurality of currencies, the plurality of transactions being based on the transmitted foreign exchange rate information;
means for scheduling execution of at least one of the plurality of transactions; and
means for arranging for billing of the client upon execution of the at least one of the plurality of transactions in a native currency of the client;
wherein the at least one of the plurality of scheduled transactions is to be executed with respect to any of a number of beneficiaries previously designated by the client.
